(19) United States
(12) Patent Application Publication
(10) Pub. No.: US 2002/0124460 A1
(43) Pub. Date: Sep. 12, 2002

(54) Nonchemical method for discovering foraging termites

(76) Inventor: Harry John Otterson, Philadelphia, PA (US)

Correspondence Address: HARRY J. OTTERSON, 7801 BUSTLETON AVE APT 206, PHILADELPHIA, PA, 19152, US

(21) Appl. No.: 09/681,265

(22) Filed: Mar. 12, 2001

(51) Int. Cl. A01M 1/20; A01M 5/00; A01M 7/00; A01M 17/00

(52) U.S. Cl. 43/132.1

(57) ABSTRACT

Non chemical baits utilizing cardboard, and wood, the termites food preference to attract the foraging termites around the foundation and away from the house and to the bait so they can easily be discovered by the homeowner before they enter and cause damage to the house.

### BACKGROUND OF INVENTION

1. The present invention is a non-chemical method for effectively attracting foraging termites by enhancing the likelihood that they will be positively attracted to the termite discovering method as it provides the termites' three basic needs, food, moisture and shelter. The Termite Bait Detecting Kit is made up of three equally important and essential parts, that when combined together make a superior attractant for foraging termites.

The Termite Bait Detecting Kit is to be used in and around the house foundation. The Termite Bait Detecting Kit is not intended to control, or eliminate termites. It is only intended to alert the homeowner to termite presence and possible termite infestation in their home. One of the greatest fears any homeowner faces is TERMITES, which DO MORE DAMAGE than fires, storms and earthquakes combined. The damage these intruders cause occurs when they eat, and they survive by eating wood, paper, cardboard and other cellulose products. If ignored, they can actually threaten the structural integrity of a house (this is where the danger lies).

Subterranean termites are the most destructive, and they are found virtually everywhere. Four kinds of termites make up a colony; workers, nymphs, soldiers and reproductives.

Workers, these are the most abundant in the colony and cause all of the damage by eating wood. (They also maintain the colony, build and repair the nest, and forage for food).

Nymphs, these immature termites develop into workers, soldiers or reproductives. (As the nymphs become larger they also begin to damage wood).

Soldiers, these termites protect the colony. They have enlarged jaws called mandibles, which they use to defend the colony, mainly against ants.

Reproductives, this caste develops sexual organs and wings. (Eyes become functional). At some signal from nature, these termites leave the colony in a swarm to start a new colony, thus spreading the damage they do. They become the king and queen of the new colony. The newly mated pair burrows into the ground to start their own colony as king and queen. And, the termite life cycle repeats itself as the queen lays eggs which become nymphs, then soldiers, workers or reproductives.

### SUMMARY OF INVENTION

In a preferred method of the invention, the “Stake”, Moisture and Top in combination, are placed in the soil adjacent to the foundation, within one inch to 18 inches out from the wall of the building. Termites forage randomly around the foundation for food. The object of this invention is to intercept foraging termites around the foundation by discovering them before they cause serious damage to the home.

Termite infestations in homes are not obvious because damage and mud tubes go unnoticed, or they are hidden. Use of this invention alerts the homeowner to the termite presence and possible infestation.

The pine wood “stake” should be spaced, on average, 12 inches to 18 inches from the closest adjacent “stake”, but, not to exceed 18 inches. The corrugated cardboard, because it is easier to eat, is a preferred food of the termites. The combination of wood, corrugated cardboard and moisture when placed together, as the invention is intended, will quickly attract the foraging termites.

Once the termites start eating the corrugated cardboard they will find the 2/8 inch cut in the “stake” that will lead them to the wood grain. Once the termites start eating along the grain, the grain will lead them up to the wood block above the “stake” (to a larger source of food). The pine wood block top also has a 2/8 inch cut on the bottom, giving the termites easy access to the grain so they can continue eating.

The 2/8 inch cut can be from ⅛ inch to ¼ inch wide and can be of various depths and lengths.

The homeowner simply removes the top block to inspect for termite activity.

### DETAILED DESCRIPTION

Description of the Preferred Embodiment 1.

The Termite Bait Detecting Kit of claim 1 including,

a) said pine “stake” with corrugated cardboard end being the bottom is place in the soil with “stake” top flush to soil surface.

b) said corrugated cardboard is a termite preferred food source and provides shelter.

c) said pine wood “stake” has a 2/8 inch cut on one side giving termites easy access to the wood grain.

d) Termites eat along the grain and the corrugation leads the termites to this point.

e) Termites eat up along the grain of the “stake” to the pine wood block top.

f) said pine wood “stake” being spaced an average of 12 inches to 18 inches from the closest adjacent stake and (1) foot out from the foundation wall.

g) said pine wood “stake” measures 4 inches long, 1-½ inches wide and ¾0 inches thick.

h) corrugated cardboard measures 4 inches long by 1-½ inches wide.

i) said pine wood “stake” measurements can vary and are not limited in length, width, thickness or shape.

j) Termites forage randomly, close to the soil surface for moisture and food.

2. The Termite Bait Detecting Kit of claim 2 including,

k) a plastic bottle used to place water around the “stake” area to help attract foraging termites.

l) various amounts of water can be applied depending on the conditions of the soil.

m) The size and shape of the bottle can vary when being packaged.

3. The Termite Bait Detecting Kit of claim 3 including,

n) a pine wood block placed on top of the soil over the “stake” to provide a larger food source, shelter and moisture.

o) said pine wood block with a 2/8 inch cut on the bottom center to give the termites easy access to the grain.

p) said pine wood block top measures 4 inches long by 2-½ inches wide and ¾ inch thick.

q) said pine wood block top is not restricted to these measurements and can vary in length, width, thickness and shape.

r) said pine wood stake and block can be substituted for another type of wood or cardboard or combination of both.

s) moisture will naturally collect under the top via dew, mist and rain.

t) Termites require food, moisture and shelter.

u) Termites when disturbed will abandon the site. By not removing the stake the termites are not disturbed.

v) The homeowner simply removes the top block to inspect for termite activity.

1. Termite Bait Detecting Kit
a) A pine wood “stake” with corrugated cardboard attached and placed in the soil to attract foraging termites and,
b) a bottle used for dispensing water to the “stake” area to enhance termite attraction and,
c) a pine wood block placed on top of the soil over the “stake” to provide a larger food source and help maintain moisture.
